(19) United States
(12) Patent Application Publication
(10) Pub. No.: US 2011/0246125 A1
(43) Pub. Date: Oct. 6, 2011

(54) Situation Awareness By Noise Analysis

(75) Inventor: Mark Shkolnikov, Herndon, VA (US)

(73) Assignee: KEYNETIK, INC., Herndon, VA (US)

(21) Appl. No.: 13/080,568

(22) Filed: Apr. 5, 2011

Related U.S. Application Data
(60) Provisional application No. 61/321,241, filed on Apr. 6, 2010.

(51) Int. Cl. G06F 15/00

(52) U.S. Cl. 702/141

(57) ABSTRACT

Embodiments of the invention relate to spectrally and spatially dissecting high frequency noise from a signal of a motion sensor. Data received from the dissected signal is reduced to statistical averages for selected frequency bands and spatial dimensions. A logic engine translates the statistical average to real-world application.

### CROSS REFERENCE TO RELATED APPLICATION(S)

This is a non-provisional utility patent application claiming benefit of the filing date of U.S. Provisional Patent Application Ser. No. 61/321,241, filed Apr. 6, 2010, and titled “Situation Awareness by Noise Analysis,” which is hereby incorporated by reference.

### BACKGROUND

This invention relates to analysis of noise from a motion sensor signal. More specifically, the invention relates to processing the signal to determine placement and/or environmental movement data from a device in communication with a sensor.

The proliferation of motion and other types of sensors into mobile devices enables new applications that take advantage of data gathered from the sensors. One of the new applications is known as a natural user interface (NUI), which is effectively invisible, or becomes invisible with successive learned interaction, to its users. The word natural is used because most computer interfaces use artificial control commands which have to be learned. A NUI relies on a user being able to carry out relatively natural motions, movements or gestures that control the computer application or manipulate the on-screen content. An important component of the NUI is an ability to detect placement of the device. Another desired component of the NUI is an ability to detect and classify background activity and to separate such background activity from intentional user movements. In other cases it may be desirable to restrict certain classes of activity depending upon the environment, such as driving and texting.

One of the challenges of implementing intelligent sensory applications on a mobile device is limitations associated with computing abilities and battery power. A common set of environmental sensors that are currently available in mobile devices include: accelerometers, gyroscopes, magnetometers, proximity sensors, light sensors, and pressure sensors. Prior art approaches to processing data acquired from these environmental sensors is computationally prohibitive with a mobile device. Accordingly, there is a need for a solution that employs sensor data in a handheld device that overcomes the limitations associated with computation and battery power.

### BRIEF SUMMARY

This invention comprises a method, system, and article for evaluation of sensor data of a mobile device to derive device placement information and/or situational awareness data associated with the device.

In one aspect of the invention, a method is provided for determining device placement and associated device activity. A motion signal is received from a sensor in communication with a mobile device. Device placement information is derived based upon signal data received from the sensor. Processing of the signal includes extracting time and spectral features, analyzing quasi-static and dynamic components of the extracted features, translating the analyzed components to objective properties, and applying a filter to the translated objective properties. Based upon the above outlined processing, device placement and device activity data is returned.

In another aspect of the invention, a method is provided for deriving situation awareness of a device based upon signal data received from a sensor in communication with a mobile device. Situation awareness data of the sensor is determined based upon signal data received from the sensor. Processing of the signal includes extracting environmental movement data from the signal data; dissecting the extracted environmental movement data, including reducing high frequency noise data to a statistical average for both a selected frequency band and spatial dimension; and classifying the environment based upon the dissected movement data. Based upon the above outlined processing, the classified environment is translated into situational awareness data.

In yet another aspect of the invention, a system is provided for extracting spectral features of a motion signal to determine device placement information of the mobile device. The system includes a mobile device having a sensor to generate a motion signal, and a computer system in communication with the mobile device. The computer system is in communication with a storage component that includes information describing device placement information. A functional unit is provided in communication with the storage component. The functional unit includes: an extraction manager to receive the motion signal and to extract time and spectral features of the signal; an analysis manager in communication with the extraction manager, the analysis manager to analyze quasi-static and dynamic components of the extracted spectral features; and a translation manager in communication with the analysis manager, the translation manager to translate the analyze components to one or more objective properties. A filter is provided in communication with the translation manager. The filter derives placement information of the mobile device based upon the translation to the objective properties.

In a further aspect of the invention, a system is provided for extracting environmental movement data of a motion signal to determine situational awareness data of the mobile device. The system includes a mobile device having a sensor to generate a motion signal, and a computer system in communication with the mobile device. The computer system is in communication with a storage component, which includes information describing situational awareness data. A functional unit is provided n communication with the storage component. The functional unit includes: an extraction manager to receive the motion signal and to extract environmental movement data from the signal; a dissection manager in communication with the extraction manager, the dissection manager dissects the extracted environmental movement data, including a reduction of high frequency noise data to a statistical average for both a selected frequency band and spatial dimension; and a classification manager in communication with the dissection manager, the classification manager classifies the environment based upon the dissected movement data. A translation manager is provided in communication with the classification manager. The translation manager translates the classified environment into situational awareness data.

In an even further aspect of the invention, a computer program product is provided for use with a mobile device to determine device placement information. The mobile device has a sensor to generate a motion signal. The computer program product includes a computer readable storage medium having computer readable program code embodied thereon. The computer readable program code is provided to receive the motion signal and derive placement information of the sensor based upon signal data received from the sensor. More specifically, the code extracts timing and spectral features of the signal, analyzes quasi-static and dynamic components of the extracted features, translates the analyzed components to objective properties, and applies a filter to the translated objective properties. Device placement and device activity data are returned based upon application of the filter.

In a yet further aspect of the invention, a computer program product is provided for use with a mobile device to determine situational awareness data. The mobile device has a sensor to generate a motion signal. The computer program product includes a computer readable storage medium having computer readable program code embodied thereon. The computer readable program code is provided to receive the motion signal and derive situation awareness based upon signal data received from the sensor. More specifically, the code extracts environment movement data from the signal, dissects the extracted data, including reduction of high frequency noise to a statistical average for a selected frequency and spatial dimension, and classifies the environment based upon the dissected data. The classified data is then translated into situational awareness data.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a set of graphs showing noise and device orientations for different placements of a mobile device.

FIG. 2 depicts a process for extracting and processing signal features so that they may be evaluated for real-time application

FIG. 3 depicts a flow chart for extracting feature data from the mobile device.

FIG. 4 depicts a diagram illustrating a signal associated with asymmetry, including representation of time and acceleration.

FIG. 5 depicts a truth value scale.

FIG. 6 depicts filtering extracted signal data for conversion of the extracted data to truth values to then enable the proper classification to real world properties.

FIG. 7 depicts an example of a device placement detection table.

FIG. 8 depicts an activity classification table.

FIG. 9 depicts block diagram illustrating tools to support derivation of device placement information.

FIG. 10 depicts a block diagram illustrating tools to support derivation of situation awareness data.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a profile manager, a hash manager, a migration manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A method and system are provided to dissect, cross correlate, and weigh signals from sensors in a manner that simplifies their perception. More specifically, the method and system address noise that in one embodiment may have been previously ignored by signal processing applications. Motion noise that exceeds a set threshold is extracted and classified according to a set of rules. In one embodiment, the class of noise is associated with motion, such as walking, and gestures. However, the invention should not be limited to these specific classes of noise and may be expanded to include other classes. Accordingly, signal data is processed to detect noise and to apply the detected noise to motion.

A process for detecting and evaluating noise, as well as the tools employed for the detection and evaluation are provided. At the outset, it should be noted that mobile devices are commonly placed within an article of clothing worn by a user, or in an accessory carried by the user, such as a bag. The user and associated environmental noises are both present in an acquired signal. The ability to extract user input allows defining signal features that are environmentally specific, and thus to classify the environment. In one embodiment, environmental information includes placement on the body of the user, as well as terrain and surface information. Frequency of walking and manual gestures both have a range of one to three hertz. Environmental noises of interest are known to have a frequency starting at about ten hertz. The nature of environmental noise commonly arises from a loose attachment of the device to the user or specific vibrations, such as automobile suspension. Accordingly, signal features for placement detection are high frequency noise, timing between successive steps, and device orientation towards gravity.

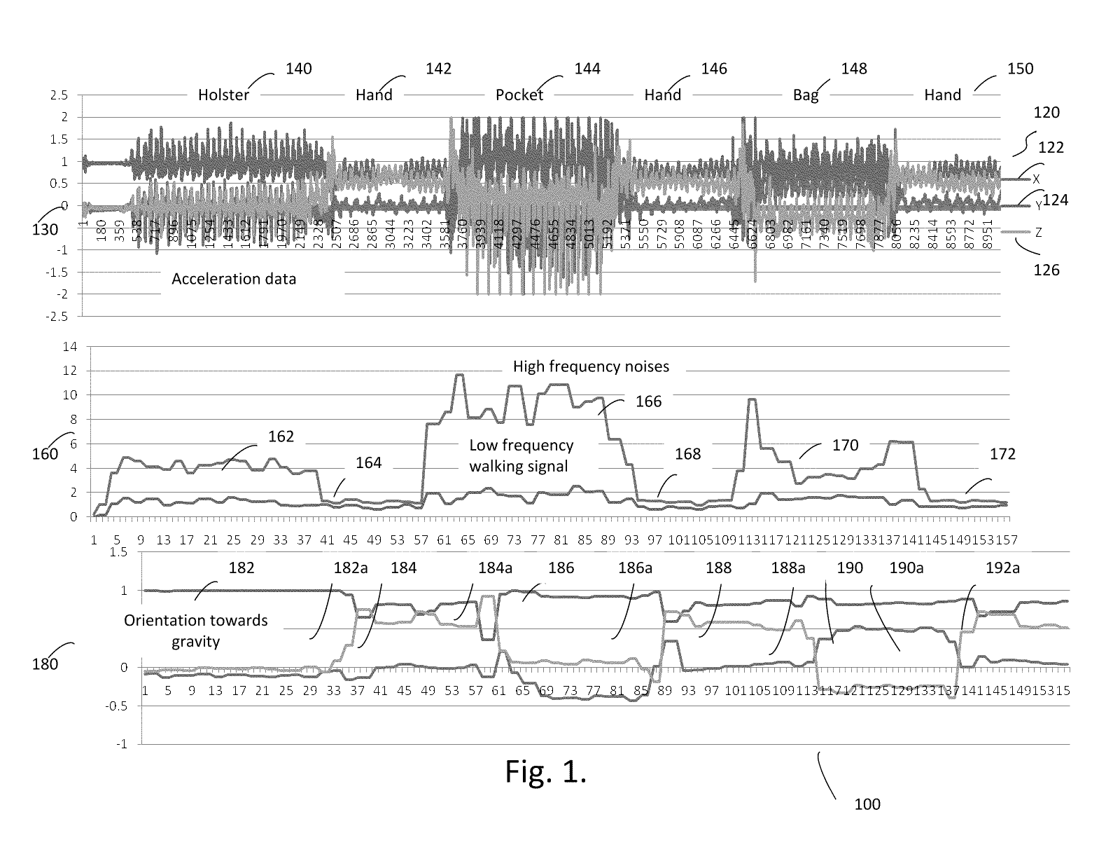

FIG. 1 is a set of graphs (100) showing noise and device orientations for different placements of a mobile device. The set of graphs illustrate acceleration data, high frequency noise, and orientation towards gravity for the mobile device. In the example reflected in the set of graphs, the mobile device has at least one tri-axis sensor for sensing data on the x-axis (122), y-axis (124), and z-axis (126), as reflected in the legend (120). In the example shown herein, the device may be placed in one or more of the following locations with respect to a user: a holster attached to clothing of the user (140), a hand (142), a pocket within clothing attached to the user (144), and a bag carried by the user (148). Furthermore, in the example shown herein, the mobile device is moved from the pocket (144) to the hand (146) and from the bag (148) back to the hand (150).

Accordingly, the graphs reflect movement of the mobile device among different positions with respect to the user.

The first of the three graphs, (130), illustrates acceleration data of the mobile device when subject to movements across the demonstrated scenarios. As shown, the acceleration data has greatest amplitude when the device is placed in the pocket (144). In addition, the acceleration data is at an increased level when placed in the holster (140) and the bag (148). The acceleration data has lower amplitude when the mobile device is placed in the hand of the user, as shown at (142), (146), and (148).

The second of the three graphs, (160), illustrate high frequency noises of the mobile device when subject moves across the demonstrated scenarios. As shown, the noise frequency is close in range, as shown at (162) by the range between amplitudes, when the device is placed in the holster (140). Placement of the device in the hand dampens the noise, as shown at (164), (168), and (172). When the device is placed in the pocket, as shown at (166), the frequency and amplitude noise spectrum is increased in comparison to the spectrum shown at (162). In one embodiment, the change in noise at (166) is associated with steps taken by the user while in motion. Finally, placement of the device in a bag being carried by the user (170) illustrates a decrease in the energy of the noise spectrum. More specifically, the noise spectrum is close and similar to that associated with placement in a holster.

The third of the three graphs, (180), illustrates data pertaining to orientation of the device towards gravity when subject to movements across the demonstrated scenarios. More specifically, the orientation data projects if and when orientation of the device has changed. In one embodiment, the orientation data is a low frequency quasi-static component of the motion signal. As shown, when the device is in the holster the orientation data is quasi-static, as shown at (182). When the device is moved form the holster to the hand (182a), data measured along the x-, y- and z-axis (122, 124, 126) changes. This change likely reflects a change in the position of the visual display of the device, as the device is likely in use. As shown, the orientation data is relatively static while the device is being hand held (184), but experiences a significant change when moved from the hand to the pocket (184a). This change is demonstrated again when the device is moved from the pocket (186) to the hand (188), as demonstrated at (186a), when the device is moved from the hand (188) to the bag (190), as demonstrated at (188a), and when the device is moved from the bag (190) to the hand (192), as demonstrated at (190a). Accordingly, changes of data associated with orientation towards gravity are demonstrated to take place when the device is moved from a relatively stationary position to the hand, and from the hand to the stationary position.

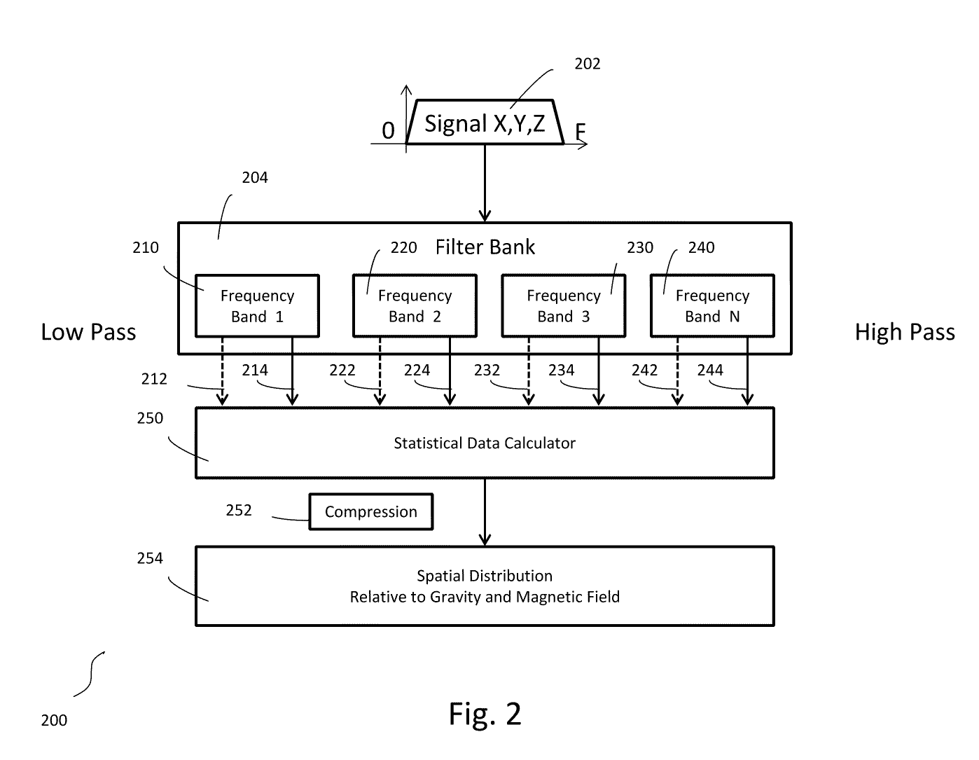

As shown in FIG. 1, patterns of data may be studied to understand how acceleration data, high frequency noises and orientation towards gravity are affected by movement and placement of a mobile device. These patterns may be applied to actual use of the mobile device in a real-time application thereof. FIGS. 2-4 described in detail below illustrated different aspects for extracting data from the sensor(s) of the mobile device.

FIG. 2 is a flow diagram (200) illustrating a process for extracting and processing signal features so that they may be evaluated for real-time application. Initially, sensor data is obtained from the mobile device (202). In one embodiment, the sensor is configured with at least one tri-axis accelerometer, or any other form of a sensor. Following gathering of the sensor data at step (202), the obtained data is applied to a filter bank (204). As shown herein, the filter bank (204) is configured with a plurality of high and low pass filters. The quantity of filters shown herein is for illustrative purposes, and the invention should not be limited to this illustrated quantity. Each set of high and low pass filters is associated with a portion of the frequency spectrum. The frequency spectrum is segmented, with each segment having a set of filters. As shown in the example herein, the frequency spectrum is split into four band segments (210), (220), (230), and (240). Each band segments has a high pass filter and a low pass filter. As shown in the example herein, a first band segment (210) has a low pass filter (212) and a high pass filter (214), a second band segment (220) has a low pass filter (222) and a high pass filter (224), a third band segment (230) has a low pass filter (232) and a high pass filter (234), and a fourth band segment (240) has a low pass filter (242) and a high pass filter (244). Accordingly, for each of the high and low pass filter, data associated with orientation towards gravity and magnetic field is extracted.

Following the filtering of the data in the filter bank (204), the data is processed to gather statistics associated therewith (250). Different types of statistics may be gathered from the filtered data, including but not limited to, range, extremum, average, variance, standard deviation, etc. In one embodiment, the statistics are computed for each of the axis components associated with the sensor. Following statistical processing of the data, the statistical data is compressed (252), employing one or more known data compression techniques. The spatial distribution of the statistical data is then determined relative to both gravity and magnetic field (254). More specifically, at (254) the statistics are projected for both orientation towards the magnetic field and orientation towards gravity. In one embodiment, the statistical data is vector data, and at step (254) a vector cross product is taken to project noise data. Accordingly, as shown herein data is obtained from the sensor(s) and dissected to extract statistical orientation data associated with the magnetic field and gravity.

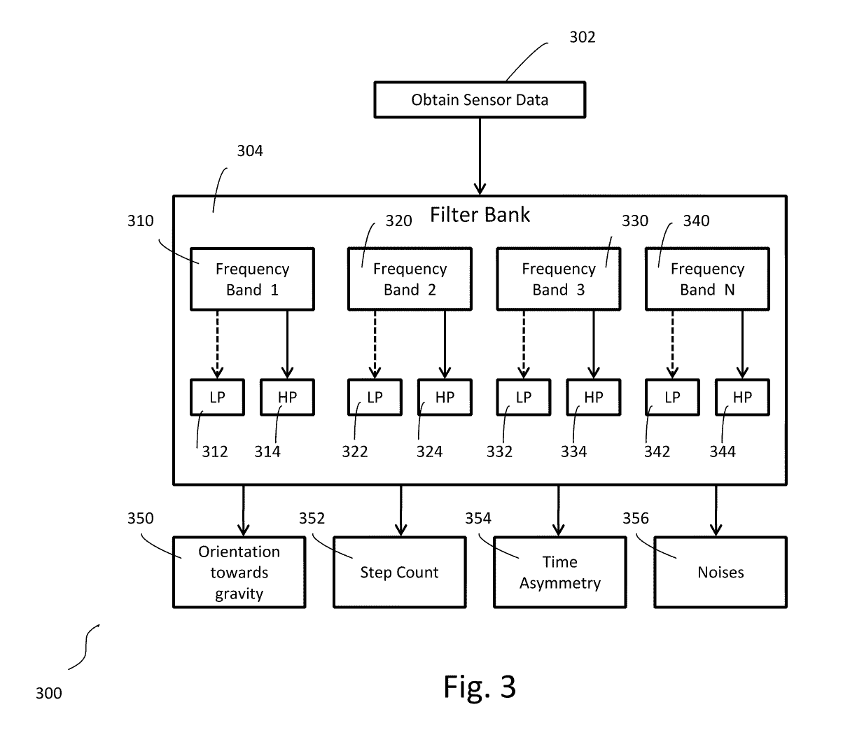

FIG. 2 as described above is limited to device orientation data with respect to gravity and magnetic field. Prior to conversion of the data from FIG. 2, feature data must be extracted and processed. FIG. 3 is a flow chart (300) illustrating the steps for extracting feature data from the mobile device. Similar to the flow shown in FIG. 2, initially, sensor data is obtained from the mobile device (302). In one embodiment, the sensor is configured with at least one tri-axis accelerometer, or any other form of a sensor. Following gathering of the sensor data at step (302), the obtained data is applied to a filter bank (304). As shown herein, the filter bank (304) is configured with a plurality of high and low pass filters. The quantity of filters shown herein is for illustrative purposes, and the invention should not be limited to this illustrated quantity. Each set of high and low pass filters is associated with a portion of the frequency spectrum. The frequency spectrum is segmented, with each segment having a set of filters. As shown in the example herein, the frequency spectrum is split into four band segments (310), (320), (330), and (340). Each band segment has a high pass filter and a low pass filter. As shown in the example herein, a first band segment (310) has a low pass filter (312) and a high pass filter (314), a second band segment (320) has a low pass filter (322) and a high pass filter (324), a third band segment (430) has a low pass filter (432) and a high pass filter (434), and a fourth band segment (340) has a low pass filter (342) and a high pass filter (344). Accordingly, for each of the high and low pass filter, data associated with orientation towards gravity, step count, time asymmetry, and noise is extracted.

Following the filtering of the data in the filter bank (304), the data is processed to extract specific features. As shown, features associated with orientation towards gravity (350), step count (352), time asymmetry (354), and noise (356) are separately extracted. A feature extraction employs a stepping window technique wherein statistical properties of the data are extracted within the window, and adjacent time segments to sample sensory data are processed. In one embodiment, a sliding window technique may be employed in addition to the stepping window technique, or in place thereof. In one embodiment the stepping window technique is applied on the sensor data level and the sliding window technique is applied on the statistical properties level. The sliding window technique extracts statistical properties of the data within the window, and averages features of data over time. However, in contrast to the stepping window technique, there is an overlap of adjacent time segments. Accordingly, as shown herein data is obtained from the sensor(s) and dissected to extract feature data associated with orientation towards gravity and noise.

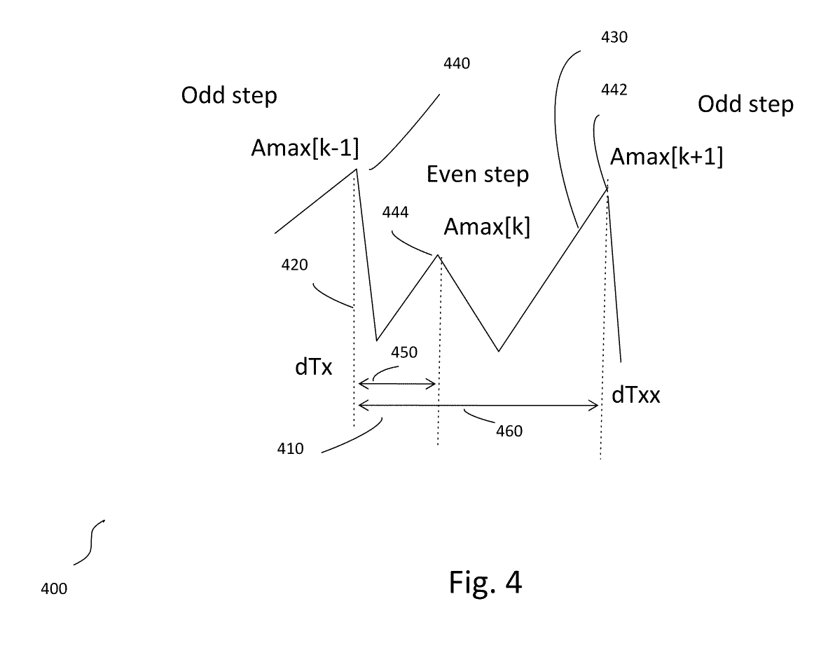

As noted above, time asymmetry is also a feature extracted from the sensor(s) of the mobile device. Walking is a unique human motion. It consists of at least two components, a center of mass motion and a limb motion. The center of mass moves up and down and forward and backward with a frequency measured in steps. At the same time, the limbs (including legs and arms) move with a frequency that is about half of the gait. Oscillations of these two frequencies result in motion signal asymmetry. By analyzing timing between acceleration peaks of odd and even steps, it is possible to determine how close the mobile device is to the limb of the user. FIG. 4 is a diagram (400) illustrating a signal associated with asymmetry, with time represented on one axis (410) and acceleration measured on a second axis (420). A periodic signal (430) is shown plotted along the axis. As shown, the signal has two high peaks (440) and (442), representing odd step counts, and one lower peak (444) representing an even step count. A first time differential (450) is measured from a first of the two high peaks (440) to the lower peak (444), and a second time differential (460) is measured from a second of the two high peaks (442) to the first of the two high peaks (440). With respect to the graph, the following formula is used to calculate asymmetry:

Asymmetry=(first time differential−second time differential)/2

In one embodiment, time asymmetry is measured between successive signal motions, and/or in at least two orthogonal spatial planes. Accordingly, a direct extraction of time asymmetry is ascertained from the extracted signal and is employed to simplify the task of determining placement of the mobile device.

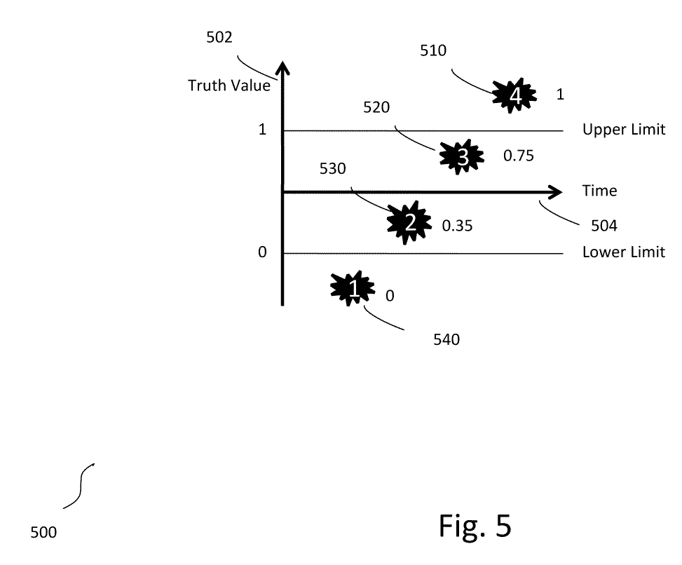

Following the dissection of the statistical data obtained in FIGS. 2-4, the data is translated to real world properties. As shown in FIGS. 2-4, the real world properties may include placement or placement transition of the mobile device. Prior to the translation to real world properties, the statistical data is converted to a truth value. The truth value is a numerical value on a scale of values. In one embodiment, the scale ranges from zero to one, with zero being the minimum truth value and one being the maximum truth value. FIG. 5 is a graph (500) illustrating a truth value scale. As shown in this example, the truth values are represented on one of the axis (502), with time represented on another axis (504). A maximum truth value (510) is shown at maximum position on the scale, and a minimum truth value (520) is shown at a minimum position on the scale. Two other truth values (530) and (540) are shown on the scale, with (530) representing a truth value closer to the minimum limit (520), and (540) representing a truth value closer to the maximum limit (510). In one embodiment, the truth values may be applied across a different scale, an inverted scale, a circular scale, etc., and as such, the invention should not be limited to the particular embodiment of the truth value scale shown herein. Accordingly, as shown in FIG. 5, a truth scale is provided to apply the statistical data to real world properties.

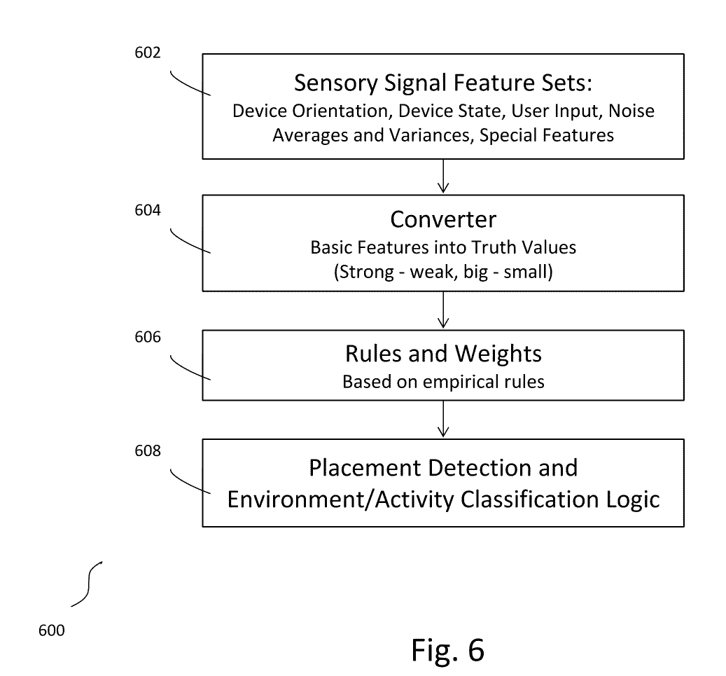

As shown in FIGS. 2-4, data is obtained from the sensor(s) to compute and extract data. FIG. 6 is a flow chart (600) illustrating a process for filtering the extracted data for conversion of the extracted data to truth values to then enable the proper classification to real world properties. As shown, the data extracted in the processes shown in FIGS. 2-4 is received (602). The extracted data may include, but is not limited to, noise, compressed statistics, orientation, features, etc. The received data is sent to a converter to convert the data to a scale value (604). More specifically, at step (604) the conversion is employed to ascertain whether the data values are weak or strong relative to objective data. In one embodiment, the conversion applies the data to truth values as described in FIG. 5 above. In one embodiment, the truth value scale ranges from zero to one with one representing a strong value and zero representing a weak value, although the invention should not be limited to this embodiment. Following the conversion to truth values at step (604), rules and weights are applied to the truth values (606). In one embodiment, different categories of data being processed may have different weights. These weights are mathematically applied to the truth values. In one embodiment, one or more of the weights are static. In another embodiment, one or more of the weights are dynamic and may be modified in real-time. Regardless of the static or dynamic value assigned to the weight, the result of applying the weight to the truth value is a numerical value, which is then applied to a placement detection mechanism (608) to characterize the environment or activity associated with the sensor data. Accordingly, a profile is generated for each data unit obtained from the sensor.

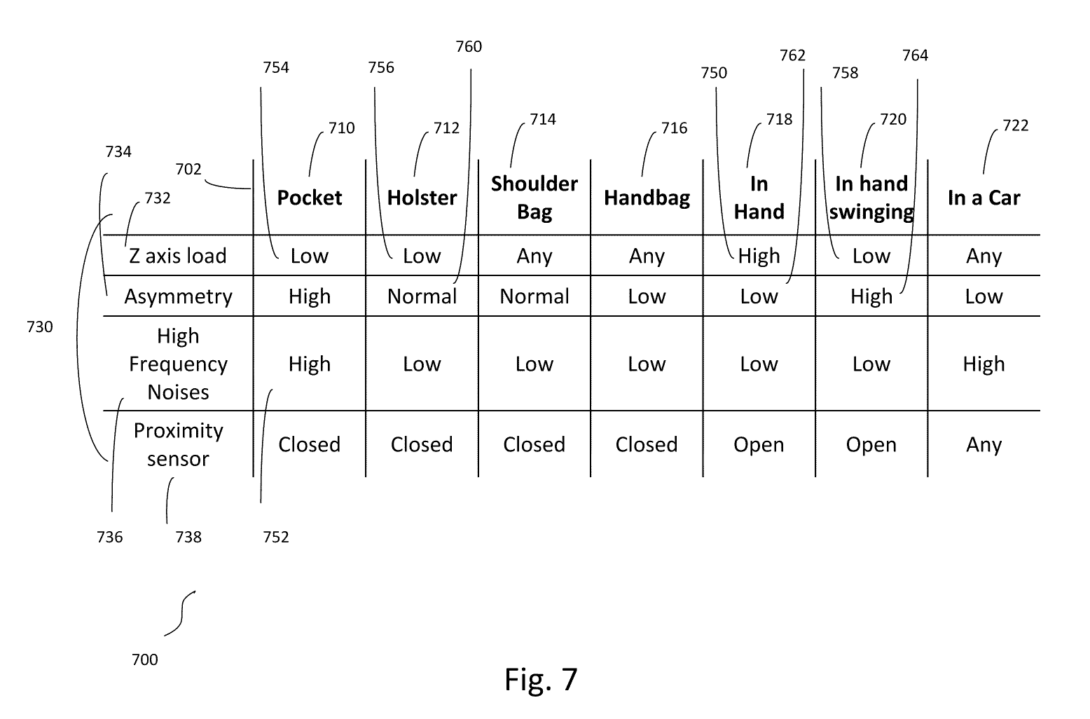

Following the profiling demonstrated in FIG. 6, the profiles generated are converted into motion detection data. FIG. 7 is an example of a device placement detection table (700). On one axis (702) a list of locations where the device may be located are provided. Some of the locations provided in FIG. 6 are based upon the locations shown in FIG. 1. More specifically, the locations provided in this example include: pocket (710), holster (712), shoulder bag (714), handbag (716), hand (718), swinging motion of hand (720), and in an automobile (722). In addition to the location data, a second axis (730) includes data pertaining to the source of the data. The sources provided in this example include: z-axis load (732), asymmetry (734), high frequency noise (736), and proximity sensor (738). For each of the values shown in the table associated with the z-axis load (732), asymmetry (734), or high frequency noise (736), the generated profile from the truth value includes, but is not limited to, low, high, and any value. In other words, the generated profile from the truth value is not the raw data, but rather whether the raw data provides, a high, low, or medium value on a scale of values.

The proximity sensor indicates if the mobile device is in an operating position. For example, in one embodiment, an operating position requires the device to be opened, and a non-operating position requires the device to be closed. Similarly, in one embodiment, an operating position requires that one surface of the mobile device be placed into a specific position with respect to the user, such as the visual display being in an exposed position. Accordingly, for the proximity sensor the values provided include closed, open, or either closed or open. For example, when the mobile device is held in the pocket (710), holster (712), shoulder bag (714), or handbag (716), the proximity sensor should have a value of closed as the mobile device should be in a closed position when held in any of these locations. Similarly, when the mobile device is held in the hand of the user, whether stationary or swinging, the proximity sensor should have a value of open as the mobile device should be in an open position at such time as it is hand held. More specifically, in the open position of the proximity sensor value it is likely that the device is in use.

The high frequency noises are shown herein when the mobile device is held in the pocket of the user and when the mobile device is in an automobile, as it is acquiring noise from the automobile. All of the other placements of the mobile device show that the high frequency noise should be in the low range.

The placement values shown in FIG. 7 are generated in FIG. 6. As shown in the example of FIG. 7, a high placement value in the Z-axis load indicates that the device is in-hand (750), and this is the location that will be returned. Likewise, a high placement value for high frequency noise (752) indicates that the device is in the pocket of the user, and this is the location that will be returned. In at least one embodiment, there may be more than one placement value per category provided on a single axis. In this case, other category placement values must be ascertained in order to precisely determine the location of the mobile device. For example, a low z-axis load value will return a device location of the pocket (754), the holster (756), and swinging in the hand (758). Since there are three optional locations, the asymmetry value must be evaluated as each of the locations (754), (756), and (758) have different asymmetry values. More specifically, a normal asymmetry value (760) together with a low z-axis load value (756) clearly indicates a holster placement (712). A low asymmetry value (762) together with a high z-axis load value (750) clearly indicates a placement in the hand of the user (718), and a low asymmetry value (764) together with a low z-axis load value (758) clearly indicates a placement in the hand in a swinging state of motion (720). Accordingly, the placement detection table provides a selection, arrangement, and coordination of values that are unique for each detected motion and device location, so that an association of the values returns a placement location of the mobile device.

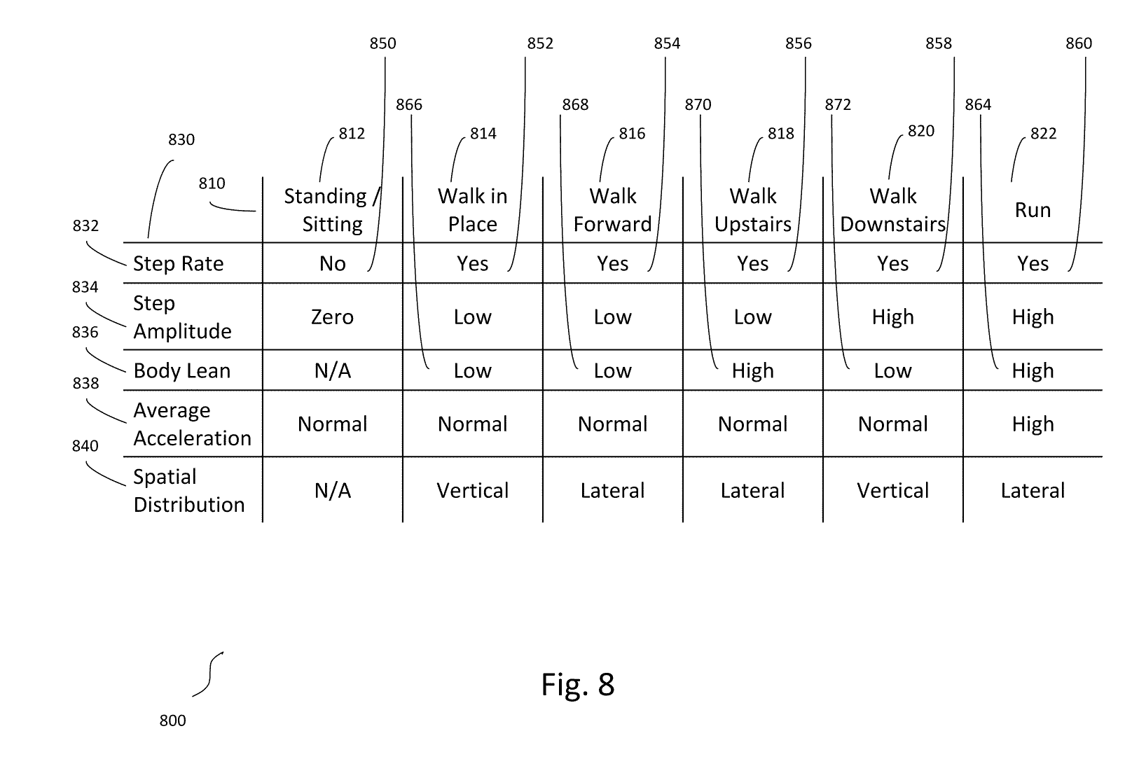

In addition to the detection placement table of FIG. 7, an activity classification table (800) is provided, as shown in FIG. 8. The table of FIG. 8 is employed to convert the profiles obtained in FIG. 6, into specific activity associated with the user and translating that activity to that of the mobile device in communication with the user. There are six activities provided in the table and shown along a first axis (810), including: standing/sitting (812), walking in place (814), walking forward (816), walking upstairs (818), walking downstairs (820), and running. In addition, five forms of acquired motion data are shown along a second axis (830), including: step rate (832), step amplitude (834), body lean (836), average acceleration (838), and spatial distribution (840). Each of the values represented in the table are acquired from the signal analysis demonstrated in FIGS. 2-4, and processed and converted into truth values in FIG. 5. Based upon the processed values together with the table shown herein, the activity of the user in communication with the mobile device may be determined.

To further explain the values in the chart provided, when a person is sitting or standing, they are stationary, and as such, they do not have a step rate (850). All other activities shown in the table have a step rate, as shown as (852), (854), (856), (858), and (860). Similarly, when the body of the user walks up a flight of stairs or runs they naturally lean forward, as reflected at (864) and (870), respectively. In all other activities of motion, the body does not have significant lean date and is assigned a low value, as shown as (866), (868), and (872). Accordingly, an activity of the user is ascertained by matching data motion data values represented along the second axis.

As shown above, the truth values for device placement are employed to determine the placement of the mobile device, and the truth values are also employed to determine the activity of the user of the device. The truth values are ascertained through noise analysis of a signal from one or more sensors in communication with the mobile device. Together, the device placement and device activity indicate the situation of the mobile device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may include, for example, but not be limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to a flowchart illustration and/or block diagrams of methods, apparatus (systems) and computer program products according to embodiments of the invention. It will be understood that each block of the flowchart illustration and/or block diagrams, and combinations of blocks in the flowchart illustration and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

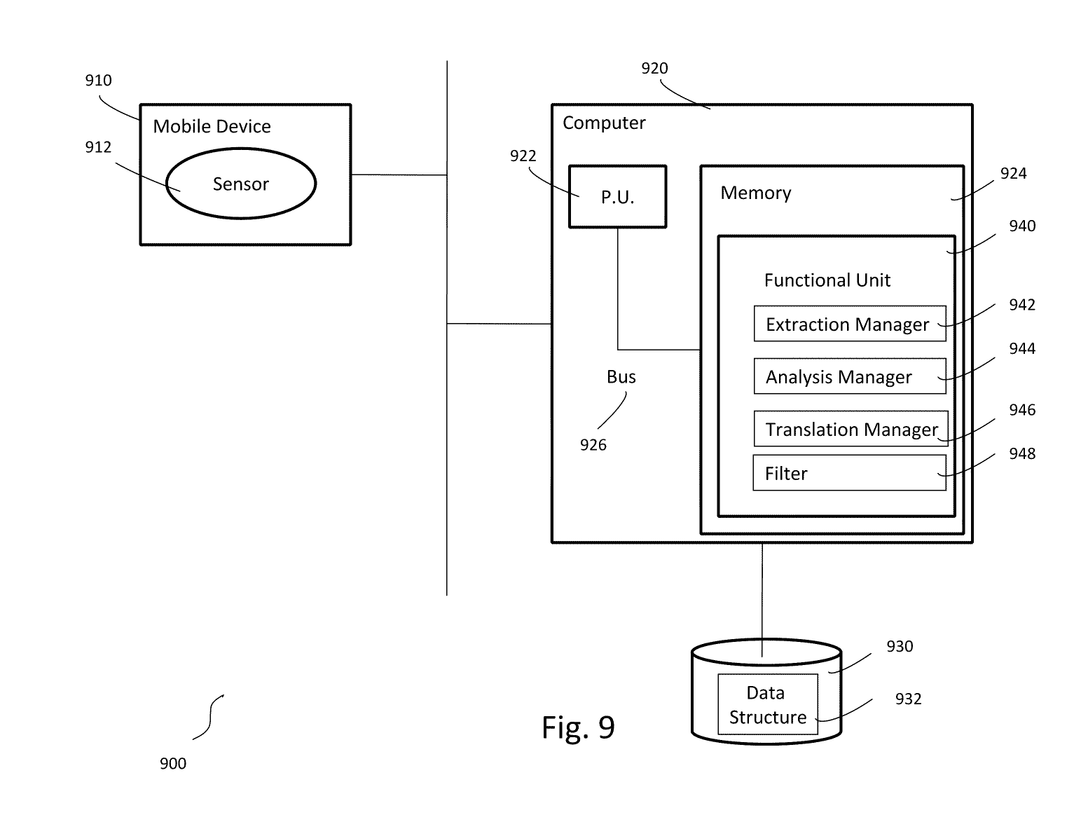

Referring now to FIG. 9 is a block diagram (900) showing a system for implementing an embodiment of the present invention. The system includes a mobile device (910) in communication with a computer (920). The mobile device (910) is provided with a sensor (912) to generate motion signals when subject to motion. In one embodiment, the sensor (912) is a tri-axis accelerometer. The mobile device (910) communicates the motion signal to the computer (920), which is configured with a processing unit (922) in communication with memory (924) across a bus (926), and data storage (930).

There are different tools employed to support derivation of placement information for the mobile device (910). For purposes of illustration, the tools will be described local to the computer (920). In one embodiment, the tools may be local to the mobile device (910). A functional unit (940) is provided in communication with the storage component (930) to provide the tools to extract and determine device placement information. More specifically, the functional unit (940) includes an extraction manager (942), an analysis manager (944), a translation manager (946), and a filter (948). The extraction manager (942) receives the motional signal and extracts time and spectral feature of the signal. The analysis manager (944), which is in communication with the extraction manager (942), analyzes both quasi-static and dynamic components of the extracted spectral features. The translation manager (946), which is in communication with the analysis manager (944), translates the analyzed components to at least one objective property. The filter (948), which is in communication with the translation manager (946), derives placement information of the device (910) based upon the translation of the objective properties as provided by the translation manager (946). In one embodiment, a data structure (932) is provided in communication with the translation manager (946) and the filter (948) to support their functionalities. As shown herein, the data structure (932) is local to data storage (930); however, the invention is not limited to this embodiment. Furthermore, the extraction manager (942) is employed to extract time asymmetry of the signal received from the mobile device (910), including measurement of time between successive signal motions. In one embodiment, the extraction manager extracts time asymmetry in two or more orthogonal spatial planes. Accordingly, the functional unit (940) provides tool to supports derivation of device placement information based upon signal processing of a motion signal of the mobile device (910).

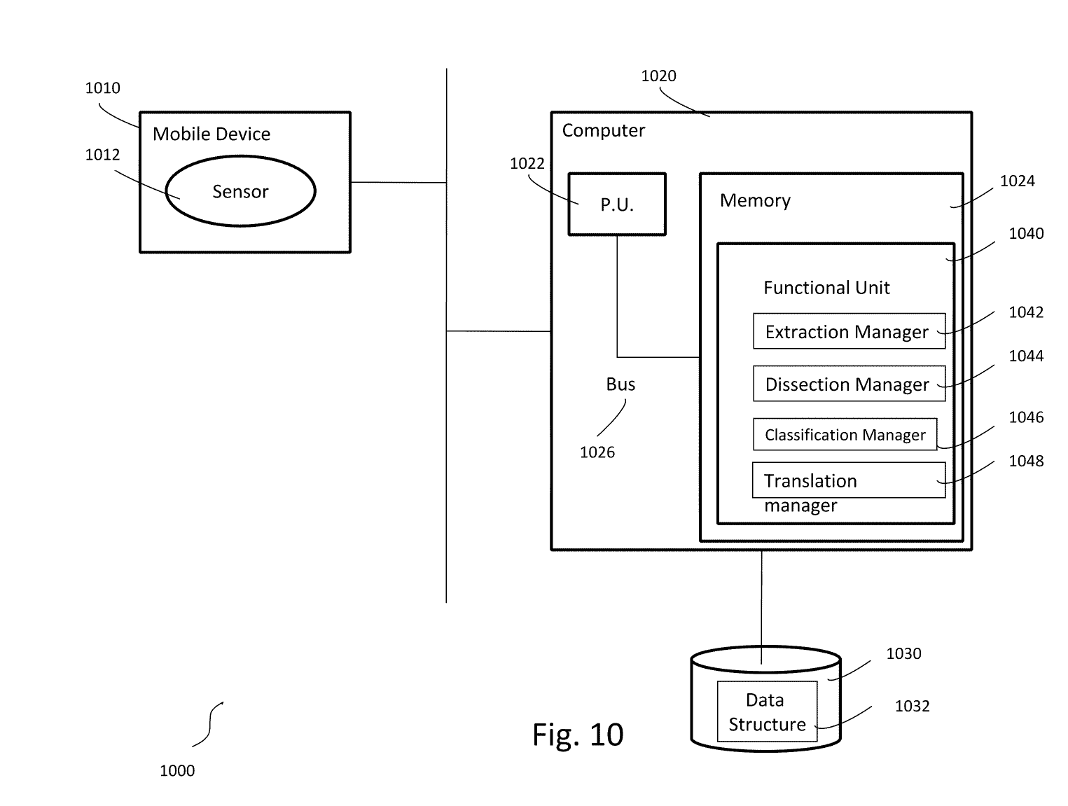

As described above, in addition to or separate from the device placement information determination, a process is provided to derive situation awareness data from the motion signal of the mobile device. Referring now to FIG. 10 is a block diagram (1000) showing a system for implementing an embodiment of the present invention. The system includes a mobile device (1010) in communication with a computer (1020). The mobile device (1010) is provided with a sensor (1012) to generate motion signals when subject to motion. In one embodiment, the sensor (1012) is a tri-axis accelerometer. The mobile device (1010) communicates the motion signal to the computer (1020), which is configured with a processing unit (1022) in communication with memory (1024) across a bus (1026), and data storage (1030).

There are different tools employed to support derivation of situational awareness data for the mobile device (1010). For purposes of illustration, the tools will be described local to the computer (1020). In one embodiment, the tools may be local to the mobile device (1010). A functional unit (1040) is provided in communication with the storage component (1030) to provide the tools to extract and derive situational awareness data. More specifically, the functional unit (1040) includes an extraction manager (1042), a dissection manager (1044), a classification manager (1046), and a translation manager (1048). The extraction manager (1042) receives the motional signal and extracts environmental movement data from the signal. In one embodiment, the extracted signal data is in the form of acceleration, rotation, or magnetic field data. The dissection manager (1044), which is in communication with the extraction manager (1042), dissects the extracted environmental movement data. In one embodiment, the extracted data includes reduction of high frequency nose data to a statistical average for both a selected frequency band and spatial dimension. In one embodiment, the environmental movement data includes noise with a frequency of at least 10 hertz, such noise including, but not limited to, the nature of the attachment of the sensor to an object in motion, change of geometry of a subject in motion, and vibration of an object in motion. The classification manager (1046), which is in communication with the dissection manager (1044), classifies the environment based upon the dissected movement data. In one embodiment, the extraction manager (1042) applies rules and weights to the dissected and classified signal data. The rules and weights return placement and device activity data, and in one embodiment, magnify one set of data while minimizing a second set of data. The translation manager (1048), which is in communication with the classification manager (1046), translates the classified environment into situational awareness data.

In one embodiment, a data structure (1032) is provided in communication with the translation manager (1048) to support the translation. As shown herein, the data structure (1032) is local to data storage (1030); however, the invention is not limited to this embodiment. The data structure (1032) includes placement and activity data, and more specifically a correlation of the dissected movement data into placement and activity data.

As identified above, the extraction, analysis, translation, dissection, and classification manager and the filter are shown residing in memory of the machine in which they reside. As described above, in different embodiment the managers and filter may reside on different machines in the system. In one embodiment, the extraction, analysis, translation, dissection, and classification manager, and the filter may reside as hardware tools external to memory of the machine in which they reside, or they may be implemented as a combination of hardware and software. Similarly, in one embodiment, the managers and filter may be combined into a single functional item that incorporates the functionality of the separate items. As shown herein, each of the manager(s) and filter are shown local to one machine. However, in one embodiment they may be collectively or individually distributed across a set of computer resources and function as a unit to manage situational awareness and signal noise. Accordingly, the managers may be implemented as software tools, hardware tools, or a combination of software and hardware tools.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

I claim:

1. A method comprising:
receiving a motion signal from a sensor in communication with a mobile device,
deriving placement information of the sensor based upon signal data received from the sensor, including:
extracting timing and spectral features from the signal;
analyzing quasi-static and dynamic components of the extracted features;
translating the analyzed components to objective properties;
applying a filter to the translated objective properties; and
returning device placement and device activity data based upon application of the filter.

2. The method of claim 1, wherein extracting time features includes extracting time asymmetry of the signal by measuring time between successive signal motions.

3. The method of claim 2, wherein extracting timing features includes extracting time asymmetry in at least two orthogonal spatial planes.

4. A method comprising:
receiving a motion signal from a sensor in communication with a mobile device,
deriving situation awareness based upon signal data received from the sensor, including:
extracting environmental movement data from the signal data;
dissecting the extracted environmental movement data, including reducing sensor data to a statistical property for both a selected frequency band and spatial dimension;
classifying the environment based upon the dissected movement data; and translating the classified environment into situational awareness data.

5. The method of claim 4, further comprising checking weighted signal data against a data structure having placement and activity data, wherein the table includes translation of the dissected movement data into placement data and activity data.

6. The method of claim 4, wherein the extracted signal data includes data selected from the group consisting of: acceleration, rotation, and magnetic field.

7. The method of claim 4, further comprising applying rules and weights to the dissected and classified signal data, wherein the rules and weights return device placement and device activity data.

8. The method of claim 7, further comprising the rules and weights magnifying one set of data and diminishing a second set of data, wherein the data is a component of the detected signal.

9. The method of claim 4, wherein environmental data includes noise with a frequency of at least 10 hertz.

10. The method of claim 9, wherein noise is selected from group consisting of: nature of attachment of the sensor to an object in motion, changes of geometry of an object in motion, and specific vibration of the object in motion.

11. The method of claim 4, wherein the sensor data is augmented by the device state data.

12. A system comprising:
a mobile device having a sensor to generate a motion signal;
a computer system in communication with the mobile device, the computer system in communication with a storage component that includes information describing device placement information;
a functional unit in communication with the storage component, the functional unit comprising:
an extraction manager to receive the motion signal and to extract time and spectral features of the signal;
an analysis manager in communication with the extraction manager, the analysis manager to analyze quasi-static and dynamic components of the extracted spectral features;
a translation manager in communication with the analysis manager, the translation manager to translate the analyze components to one or more objective properties; and
a filter in communication with the translation manager, the filter to derive placement information of the mobile device based upon the translation to the objective properties.

13. The system of claim 12, wherein the extraction manager extracts time asymmetry of the signal including measurement of time between successive signal motions.

14. The system of claim 13, wherein the extraction manager extracts time asymmetry in at least two orthogonal spatial planes.

15. A system comprising:
a mobile device having a sensor to generate a motion signal;
a computer system in communication with the mobile device, the computer system in communication with a storage component that includes information describing situational awareness data;
a functional unit in communication with the storage component, the functional unit comprising:
an extraction manager to receive the motion signal and to extract environmental movement data from the signal;
a dissection manager in communication with the extraction manager, the dissection manager to dissect the extracted environmental movement data, including a reduction of the sensor data to a statistical property for both a selected frequency band and spatial dimension;
a classification manager in communication with the dissection manager, the classification manager to classify the environment based upon the dissected movement data; and
a translation manager in communication with the classification manager, the translation manager to translate the classified environment into situational awareness data.

16. The system of claim 15, further comprising the translation manager to employ an activity data structure to translate the dissected movement data into placement and activity data.

17. The system of claim 15, wherein the extracted signal data includes data selected from the group consisting of: acceleration, rotation, and magnetic field.

18. The system of claim 15, further comprising the translation manager to apply rules and weights to the dissected and classified signal data.

19. A computer program product for use with a mobile device, the mobile device having a sensor to generate a motion signal, the computer program product comprising a computer readable storage medium having computer readable program code embodied thereon, which when executed causes a computer to implement the method comprising:
receiving the motion signal and deriving placement information of the sensor based upon signal data received from the sensor, including:
extracting timing and spectral features of the signal;
analyzing quasi-static and dynamic components of the extracted features;
translating the analyzed components to objective properties;
applying a filter to the translated objective properties; and
returning device placement and device activity data based upon application of the filter.

20. The computer program product of claim 19, wherein extracting time features includes extracting time asymmetry of the signal by measuring time between successive signal motions.

21. The computer program product of claim 20, wherein extracting timing features includes extracting time asymmetry in at least two orthogonal spatial planes.

22. A computer program product for use with a mobile device, the mobile device having a sensor to generate a motion signal, the computer program product comprising a computer readable storage medium having computer readable program code embodied thereon, which when executed causes a computer to implement the method comprising:
receiving the motion signal from the sensor in communication with a mobile device,
deriving situation awareness based upon signal data received from the sensor, including:
extracting environmental movement data from the signal data;
dissecting the extracted environmental movement data, including reducing the data to a statistical property for both a selected frequency band and spatial dimension;
classifying the environment based upon the dissected movement data; and
translating the classified environment into situational awareness data.

23. The computer program product of claim 22, further comprising checking weighted signal data against a data structure having placement and activity data, wherein the table includes translation of the dissected movement data into placement data and activity data.

24. The computer program product of claim 22, wherein the extracted signal data includes data selected from the group consisting of: acceleration, rotation, and magnetic field.

25. The computer program product of claim 22, further comprising applying rules and weights to the dissected and classified signal data, wherein the rules and weights return device placement and device activity data.

26. The computer program product of claim 25, further comprising the rules and weights magnifying one set of data and diminishing a second set of data, wherein the data is a component of the detected signal.

27. The computer program product of claim 22, wherein environmental data includes noise with a frequency of at least 10 hertz.

28. The computer program product of claim 27, wherein noise is selected from group consisting of: nature of attachment of the sensor to an object in motion, changes of geometry of an object in motion, and specific vibration of the object in motion.

29. The computer program product of claim 22, wherein the sensor data is augmented by the device state data.
